(19) United States
(12) Patent Application Publication
(10) Pub. No.: US 2009/0052840 A1
(43) Pub. Date: Feb. 26, 2009

(54) Optical waveguide type optical coupling arrangement

(75) Inventors: Seiji Kojima, Hitachi (JP); Akihito Hongo, Hitachi (JP); Kazumasa Ohsono, Hitachi (JP); Bing Yao, Hitachi (JP); Akio Satou, Toyota-shi (JP); Kohei Yanaka, Nishikamo-gun (JP); Kazuo Hasegawa, Nisshin-shi (JP); Daisuke Inoue, Nagoya-shi (JP); Hiroshi Ito, Kasugai-shi (JP); Tadashi Ichikawa, Nagoya-shi (JP); Kazuya Saito, Nagoya-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: HITACHI CABLE, LTD., Tokyo (JP); TOYOTA JIDOSHA KABUSHIKI KAISHA, Toyota-shi (JP); Toyota School Foundation, Aichi-ken (JP)

(21) Appl. No.: 12/222,971

(22) Filed: Aug. 20, 2008

(30) Foreign Application Priority Data
Aug. 21, 2007 (JP) 2007-214652

(51) Int. Cl. G02B 6/26

(52) U.S. Cl. 385/39

(57) ABSTRACT

A plurality of light emitting elements 11 are arranged in parallel with a constant pitch to provide a semiconductor laser bar 10. An optical waveguide 20 has a core part 21 for guiding a light emitted from each of the light emitting elements 11 and a cladding part 22 formed around the core part 21. An optical fiber 30 has a core 31 and a cladding 32 formed around the core 31 for confining the light to the core 31. The optical waveguide is bonded to a side surface of the optical fiber 30, and the light emitted from the semiconductor laser bar 10 is inputted to a side surface of the core 31 of the optical fiber 30 via the core part 21 of the optical waveguide 20.

The present application is based on Japanese Patent Application Nos. 2007-214652 filed on Aug. 21, 2007, the entire contents of which are incorporated herein by reference.

### BACKGROUND OF THE INVENTION

1. Field of the Invention

The present invention relates to an optical waveguide type optical coupling arrangement for optically coupling a semiconductor laser bar and an optical fiber, in more particular, to an optical waveguide type optical coupling arrangement to be applied to an optical fiber laser.

2. Related Art

As to a light emitting part of a semiconductor laser, a light emitting element is provided a basic unit. The light emitting part in which several tens pieces of the light emitting elements are arranged in parallel in a lateral direction is called as a “laser bar”, and the light emitting part in which several pieces of the laser bars are arranged in a vertical direction is called as a “laser stuck”.

The structure of the conventional laser bar will be explained referring to data sheets of a laser bar “BAC50c-9XX-03/04” manufactured by Bookham, Inc. (http://www.bookham.com/datasheets/hpld/BAC50C-9xx-03.cfm) searched by Mar. 1, 2007.

FIG. 18 is a perspective view of a semiconductor laser as the light emitting element 61. A laser bar 60 comprises a plurality of light emitting elements 61 arranged in parallel in a substrate 62, and the number of the light emitting elements 61 is nineteen.

The light emitting element 61 has a thickness t6 of 1 μm, a width w6 of 100 μm, and a resonant length l6 of 24 mm as shown in FIG. 18.

FIG. 19 is a perspective view of the laser bar 60 in which the light emitting elements 61 are incorporated.

The light emitting elements 61 are arranged in parallel within an interval (pitch) of d6 of 500 μm in the substrate 62 as shown in FIG. 19. A total width w60 of the light emitting elements 61 arranged in lateral direction is 50 mm in this example.

FIG. 20 is an explanatory diagram showing a spread angle of a light emitted from the laser bar 60.

In general, as shown in FIG. 20, the light emitted from light emitting parts of the light emitting elements 61 (the number of the light emitting elements 61 is nineteen) has a spread angle θx of about 6′ (90% of a light quantity) in an x-axis direction and a spread angle θy of about 60′ (90% of the light quantity) in a y-axis. Herein, when the spread angle θx is about 6′, a numerical aperture (NA) is sin 6′, namely 0.10 (NA=sin 6′=0.10). Similarly, when the spread angle θy is about 60′, the NA is sin 60′, namely 0.87 (NA=sin 60′=0.87).

Therefore, a light emitting region 63 in a z-axis which is distant enough from the light emitting parts of the laser bar 60 has a shape as shown in FIG. 20.

FIG. 21 is an explanatory diagram showing a conventional coupling arrangement between a laser bar 60 comprising a semiconductor laser and an optical fiber 70 by an optical waveguide structure 65.

For inputting the light emitted from the laser bar 60 into the optical fiber 70, there is a technique of converting a shape of the light emitted from the laser bar 60 from an elliptical shape to a circular shape by using the optical waveguide structure 65, and inputting the converted light with high efficiency into the optical fiber 70, as shown in FIG. 21. Japanese Patent No. 3607211 discloses an example of such coupling arrangement.

FIG. 22 is an explanatory diagram showing another conventional coupling arrangement between a laser bar 60 comprising a semiconductor laser and an optical fiber 70 by optical fibers 72.

As shown in FIG. 22, each of the light emitting elements 61 in the laser bar 60 is optically coupled to each of the optical fibers 72 to be bundled. Thereafter, the optical fibers 72 to be bundled are bundled by a binder 72a to provide a bundled part 72b, and the bundled part 72b is optically coupled to the optical fiber 70 as a target. Herein, a beam spread angle of the laser bar 60 in the y-axis direction is large, the beam spread angle of the laser bar 60 in the y-axis direction is reduced by using a collimate lens 71 and optically coupled to the optical fibers 72 to be bundled.

FIGS. 23A and 23B are lateral cross sectional views of the bundled part 72b of the optical fiber 72 and the optical fiber 70.

As shown in FIGS. 23A and 23B, the cross sections of the bundled part 72b of the optical fiber 72 and the optical fiber 70 are determined such that a distance between cores 73 provided as an outermost layer in the optical fiber 72 coincides with a diameter of a core 74 of the optical fiber 70.

FIGS. 24A and 24B are explanatory diagrams showing a still another conventional coupling arrangement between a semiconductor laser and a multimode optical fiber 86 by an optical fiber 82.

Japanese Patent No. 3337691 discloses an example of techniques for inputting the laser light emitted from the semiconductor laser to a target optical fiber from a side surface by using a feeding optical fiber. There is a technique of converting a shape of the light emitted from a semiconductor light emitting element 80 (a single light emitting element) from an elliptical shape to a circular shape by using an cylindrical lens 81 and inputting the converted light with high efficiency into an optical fiber for transmission (feeding optical fiber) 82 as shown in FIG. 24A, while feeding a light quantity of a light emitted from a multimode light source 84 to a multimode optical fiber 86 via the feeding optical fiber 82 at a side surface of the multimode optical fiber 86 at another end of the feeding optical fiber 82 as shown in FIG. 24B.

However, in the optical coupling arrangement as shown in FIG. 21, there is a disadvantage in that difficulties exist in manufacturing the optical waveguide structure 65. Further, the optical coupling method shown in FIG. 21 is a technique of inputting the laser light into an end surface of the target optical fiber 70, so that it is difficult to input the laser light with high efficiency to the optical fiber 70 when the laser light is largely spread in the y-axis direction, i.e. the spread angle in the y-axis direction is large.

Further, in the optical coupling arrangement using the bundling of the optical fibers 72 as shown in FIG. 22, there is a disadvantage in that a structure thereof is complicated since the optical coupling to the optical fibers 72 to be bundled is performed by using the means such as the collimate lens 71 interposed between the laser stuck 60 and the optical fibers 72 to be bundled. Further, the bundled part 72b includes cladding layers of the optical fibers 72 to be bundled, so that it is impossible to input the laser light with high efficiency to the optical fiber 70 unless the diameter of the core 74 of the optical fiber 70 is greater than a diameter of a total region of the cores 73 to which the laser light is guided.

Still further, in the optical coupling arrangement as shown in FIG. 24, the laser light is inputted from one light emitting element 80 for one optical transmission fiber 82. Therefore, for the purpose of using a plurality of the optical transmission fibers 82, a plurality of the light emitting elements 80 for outputting the laser light are required and the number of the light emitting elements 80 should be same as that of the optical transmission fibers 82. For example, when the laser light emitted from the light emitting element 80 is input to the optical fiber 86 from the side surface as shown in FIG. 24B, the number of optical coupling points to the side surface of the optical fiber 86 is increased since one transmission optical fiber 86 is required for each one light emitting element. Therefore, a total structure of an optical coupling apparatus is complicated and large-scaled.

In addition, a mechanism for inputting the laser light to the transmission optical fiber 82 using the cylindrical lens 81 as shown in FIG. 24A will be complicated in order to apply the optical coupling arrangement as shown in FIGS. 24A and 24B to the laser bar.

### SUMMARY OF THE INVENTION

Therefore, it is an object of the present invention to provide an optical waveguide type optical coupling arrangement for optically coupling the light emitted from a semiconductor laser bar to an optical fiber with high efficiency by a simple structure.

According to a feature of the invention, an optical waveguide type optical coupling arrangement comprising:

a semiconductor laser bar comprising a plurality of light emitting elements arranged in parallel;

an optical waveguide comprising a core part for guiding a light emitted from each of the light emitting elements in the semiconductor laser bar and a cladding part formed around the core part; and

an optical fiber comprising a core and a cladding formed around the core for confining the light into the core;

wherein the optical waveguide is bonded to a side surface of the optical fiber,

wherein the light emitted from the laser bar is input to a side surface of the core of the optical fiber.

In the optical waveguide type optical coupling arrangement, the core part of the optical waveguide may have a tapered shape such that a spread angle of the light emitted from the light emitting element is not greater than an acceptance angle of the optical fiber.

In the optical waveguide type optical coupling arrangement, a size of the core part of the optical waveguide at an output end side may be determined such that a spread angle of the light at the output end side is not greater than an acceptance angle of the optical fiber.

In the optical waveguide type optical coupling arrangement, the core of the optical fiber may comprise a bonding surface bonded to the optical waveguide, the optical waveguide comprises a bonding surface bonded to the core, and the bonding surface of the core is flat to the bonding surface of the optical waveguide.

In the optical waveguide type optical coupling arrangement, the core part may comprise a mechanism for changing a spread angle of a light propagated therethrough by changing a shape of the core part along a light guiding axis.

In the optical waveguide type optical coupling arrangement, the core part comprises a deformed part that is deformed along a light guiding axis fiber and the deformed part changes a spread angle of a light propagated through the deformed part.

In the optical waveguide type optical coupling arrangement, the core part of the optical waveguide may comprise a side surface facing to the semiconductor laser bar and the side surface of the core part is lens-processed.

In the optical waveguide type optical coupling arrangement, the core part of the optical waveguide may comprises a side surface facing to the semiconductor laser bar, and the side surface of the core part has a convex cross section.

In the optical waveguide type optical coupling arrangement, it is preferable that the optical waveguide changes a direction of the light emitted from each of the light emitting elements and propagated through the core part and guides the light to a side surface of the optical fiber.

In the optical waveguide type optical coupling arrangement, the optical fiber may comprise a double clad fiber for an optical fiber laser, comprises a core doped with a rare earth element, and two different claddings formed around the core.

According to another feature of the invention, an optical waveguide for an optical waveguide type optical coupling arrangement comprises:

a core part for guiding a light emitted from each of the light emitting elements in the semiconductor laser bar; and

a cladding part formed around the core part,

wherein the core part comprises a deformed part that is deformed along a light guiding axis and the deformed part changes a spread angle of a light propagated through the deformed part.

### EFFECT OF THE INVENTION

According to the present invention, it is possible to provide an optical waveguide type optical coupling arrangement for optically coupling the light emitted from a semiconductor laser bar to an optical fiber with high efficiency by a simple structure.

### BRIEF DESCRIPTION OF THE DRAWINGS

Next, preferred embodiments according to the present invention will be explained in conjunction with appended drawings, wherein:

FIG. 1 is a schematic diagram of an optical waveguide type optical coupling arrangement in a first preferred embodiment according to the present invention;

FIG. 2 is a partial cross sectional view along yz-plane of the optical waveguide type optical coupling arrangement shown in FIG. 1;

FIG. 3 is an explanatory diagram showing a cross section of an optical waveguide part in the optical waveguide type optical coupling arrangement shown in FIG. 1;

FIG. 4 is a partial cross sectional view along y- and t-axes of an optical waveguide type optical coupling arrangement in a variation of the first preferred embodiment shown in FIG. 1;

FIG. 5 is an explanatory diagram showing a core part of an optical waveguide in an optical waveguide type optical coupling arrangement in the second preferred embodiment according to the invention;

FIG. 6 is a simplified schematic diagram showing a structure of the core part in the optical waveguide as shown in FIG. 5;

FIG. 7A and FIG. 7B are explanatory diagrams showing a relationship between a size of a light emitting element and an divergence angle in the optical waveguide type optical coupling arrangement shown in FIG. 5;

FIG. 8 is a cross sectional view of an optical fiber in the optical waveguide type optical coupling arrangement shown in FIG. 5;

FIGS. 9A and 9B are cross sectional views of variations of the optical fiber in the optical waveguide type optical coupling arrangement shown in FIG. 5;

FIG. 10A and FIG. 10B are explanatory diagrams showing a relationship between a size of an optical waveguide coupling part and an divergence angle in the optical waveguide type optical coupling arrangement shown in FIG. 5;

FIG. 11 is a simplified schematic diagram showing a structure of a variation of the core part in the optical waveguide as shown in FIG. 6;

FIG. 12A and FIG. 12B are explanatory diagrams showing a relationship between a size of an input and output part and a divergence angle in the core part shown in FIG. 11;

FIG. 13 is a schematic diagram of an optical waveguide type optical coupling arrangement in a third preferred embodiment according to the present invention;

FIG. 14 is a table of graphs showing a coupling efficiency of an input laser light to the optical fiber in the present invention;

FIG. 15 is a schematic diagram of an optical waveguide type optical coupling arrangement applied to an optical fiber laser in a fourth preferred embodiment according to the invention;

FIG. 16 is a schematic diagram of a perspective view of an optical waveguide structure in the optical waveguide type optical coupling arrangement according to the invention;

FIGS. 17A and 17B are explanatory diagrams showing a method for forming an optical waveguide core in the optical waveguide structure in the invention;

FIG. 18 is a perspective view of a semiconductor laser as the light emitting element;

FIG. 19 is a perspective view of the laser bar in which the light emitting elements are incorporated.

FIG. 20 is an explanatory diagram showing a spread angle of a light emitted from the laser bar;

FIG. 21 is an explanatory diagram showing a conventional coupling arrangement between a laser bar comprising a semiconductor laser and an optical fiber by an optical waveguide structure;

FIG. 22 is an explanatory diagram showing another conventional coupling arrangement between a laser bar comprising a semiconductor laser and an optical fiber by optical fibers;

FIGS. 23A and 23B are lateral cross sectional views of the bundled part of the optical fiber and the optical fiber; and

FIGS. 24A and 24B are explanatory diagrams showing a still another conventional coupling arrangement between a semiconductor laser and a multimode optical fiber by an optical fiber.

### DETAILED DESCRIPTION OF PREFERRED EMBODIMENTS

Next, preferred embodiments according to the present invention will be explained in more detail in conjunction with the appended drawings.

### First Preferred Embodiment

FIG. 1 is a schematic diagram of an optical waveguide type optical coupling arrangement for inputting a laser light emitted from a semiconductor laser bar by using an optical waveguide in a first preferred embodiment according to the present invention.

An optical waveguide type optical coupling arrangement 100 comprises a semiconductor laser bar 10, an optical waveguide 20, and an optical fiber 30, in which a laser light emitted from the semiconductor laser bar 10 is inputted to a side surface of the optical fiber 30 via the optical waveguide 20.

The semiconductor laser bar 10 comprises a plurality of light emitting elements 11 arranged in parallel in a lateral direction with a constant pitch. The conventional semiconductor laser bar such as “BAC50c-9XX-03/04” may used as the semiconductor laser bar 10.

The optical waveguide 20 comprises a plurality of core parts 21 and a cladding part 22. The core parts 21 are arranged in a lateral direction with a constant pitch.

The optical fiber 30 comprises a core 31 and a cladding 32 provided at an outer periphery of the core 31.

It is preferable that the optical waveguide 20 has a plate-like structure as shown in FIG. 1, in order to facilitate a bonding (connection) between the optical waveguide 20 and the semiconductor laser bar 10 and a bonding between the optical waveguide 20 and the optical fiber 30.

In the optical waveguide 20, the core parts 21 are formed with the pitch equal to the pitch between the adjacent light emitting elements 11 at a side surface facing to the semiconductor laser bar 10. The laser light emitted from each of the light emitting elements 11 of the semiconductor laser bar 10 is transmitted through the core part 21.

On the other hand, in the optical fiber 30 to which the laser light is inputted, it is preferable that the core 30 has a non-circular shape in order to facilitate a connection between the optical fiber 30 and the plate-like optical waveguide 20 and accelerate the input of the laser light. For example, the core 31 may have a tambour shape having two flat sides and two arched sides in its cross section.

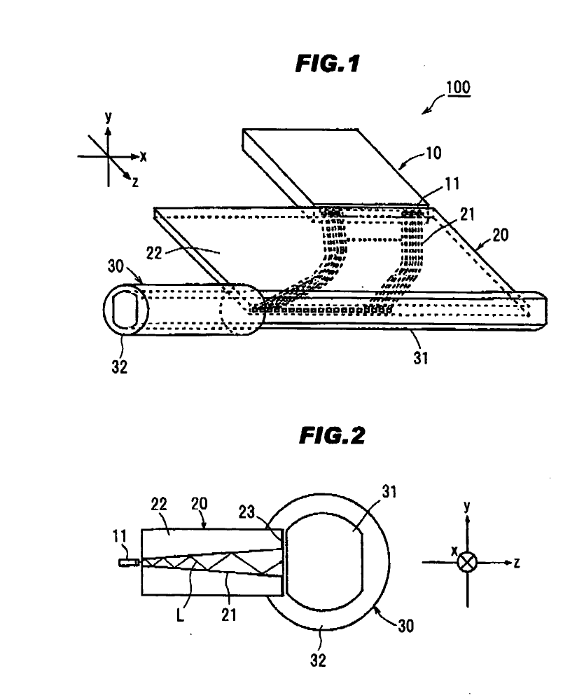

FIG. 2 is a partial cross sectional view along yz-plane of the optical waveguide type optical coupling arrangement shown in FIG. 1.

In FIG. 2, a zigzag line shows a transmission of the laser light L emitted from the light emitting element 11.

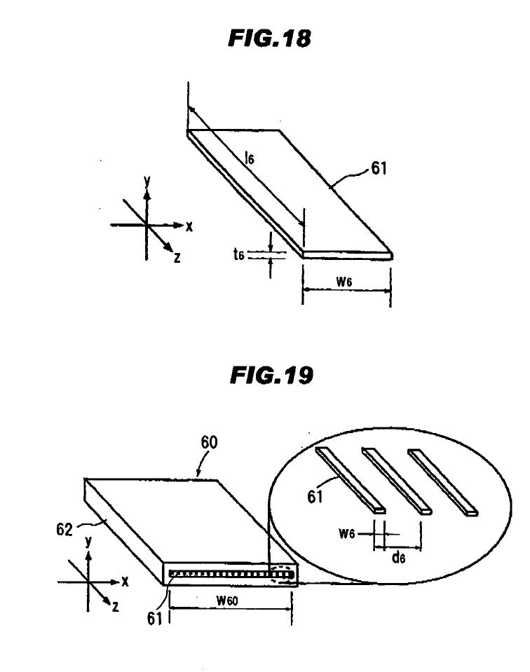

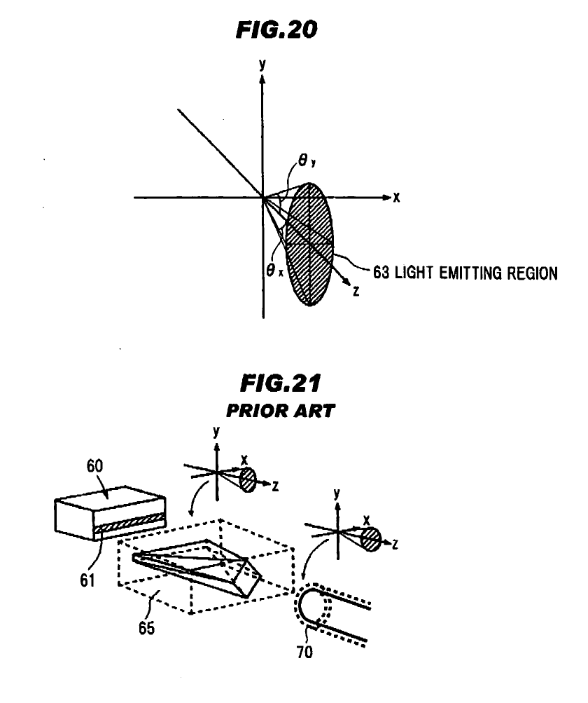

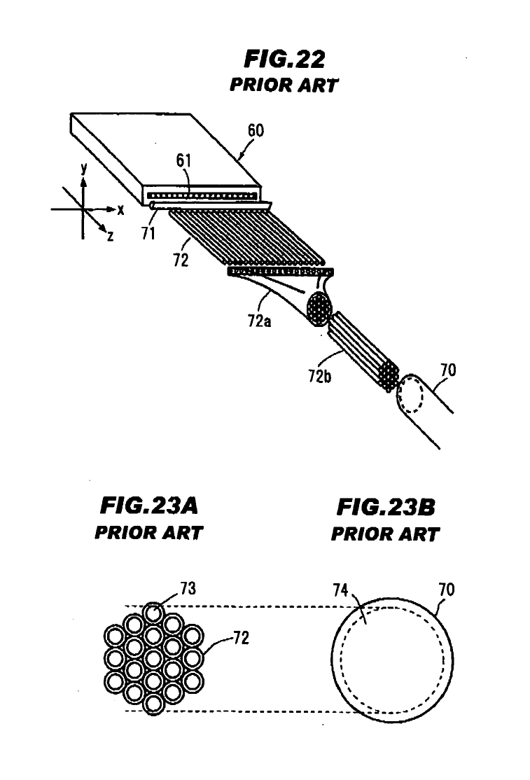

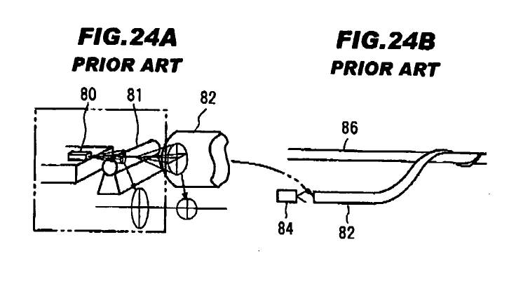

The light emitting element 11 of the semiconductor laser bar 10 has a large spread angle in the y-axis direction as explained with referring to FIG. 18. In general, the spread angle of the light element 11 is in general about 60′. An acceptance angle of the optical fiber is determined by a relative refractive index difference between the core and the cladding of the optical fiber. NA of a multimode optical fiber having a large diameter core is in general 0.2 to 0.5 (corresponding to 11′ to 30′). Therefore, the spread angle of the light emitting element 11 in the y-axis direction is greater than the acceptance angle of the conventional optical fiber, so that it is impossible to realize an optical coupling to the conventional optical fiber with high efficiency.

Therefore, the core part 21 of the optical waveguide 20 as shown in FIG. 2 is formed to have a tapered shape and a reflection coating 23 is formed at an end surface of the cladding part 22 at an output end side, so as to reduce the spread angle in the y-axis direction.

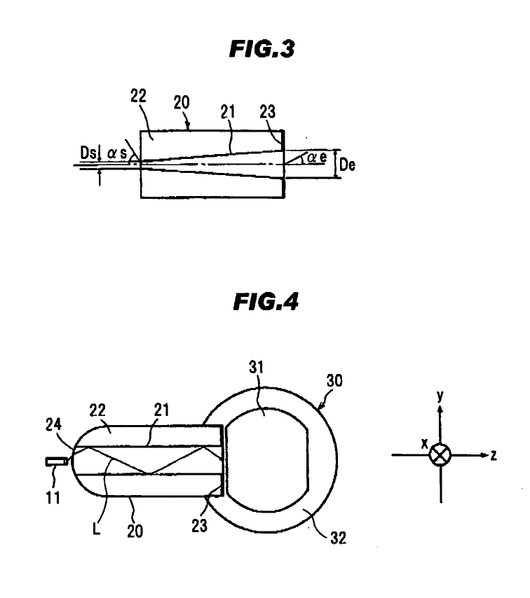

FIG. 3 is an explanatory diagram showing a cross section of an optical waveguide part in the optical waveguide type optical coupling arrangement shown in FIG. 1.

Herein, the reduction in the spread angle in the y-axis direction is approximately expressed by formula (I), by treating the spread angle in the y-axis independently:

Ds×sin(αs)=De×sin(αe) (1),

wherein Ds is a core length in the y-axis direction at an input end side of the optical waveguide, De is a core length in the y-axis direction at an output end side of the optical waveguide, αs is a spread angle in the y-axis direction at the input end side of the optical waveguide, and αe is a spread angle in the y-axis direction at the output end side of the optical waveguide.

Accordingly, it is possible to realize the high efficiency optical coupling in the y-axis direction with the optical fiber 30, by determining the core length De in the y-axis direction at the output end side (i.e. at a side of the reflection coating 23) such that the spread angle αe in the y-axis direction at the output end (i.e. at the side of the reflection coating 23) in FIG. 3 is equal to or less than the acceptance angle of the optical fiber 30.

FIG. 4 is a partial cross sectional view along yz-plane of an optical waveguide type optical coupling arrangement in a variation of the first preferred embodiment shown in FIG. 1. In FIG. 4, the optical waveguide 20 has a convex shaped end surface 24 which is opposite to the reflection coating 23. The end surface 24 is lens-processed.

It is also possible to realize the high efficiency optical coupling with the optical fiber 30, by conducting a lens processing on the end surface 24 at the input end side facing to the semiconductor laser bar 10 (i.e. at a side of the light emitting element 11) in order to reduce the spread angle αe in the y-axis direction at the output end side (i.e. at the side of the reflection coating 23) as shown in FIG. 4.

It is effective to provide the reflection coating 23 on the end surface facing to the optical fiber 30 in the optical waveguide 20 shown in FIGS. 2 to 4, in order to prevent the light inputted to the core 31 in the optical fiber 30 from being incident to the cladding part 22 in the optical waveguide 20 when the input light is propagated through the core 31 of the optical fiber 30, thereby realizing the high efficiency optical coupling.

### Second Preferred Embodiment

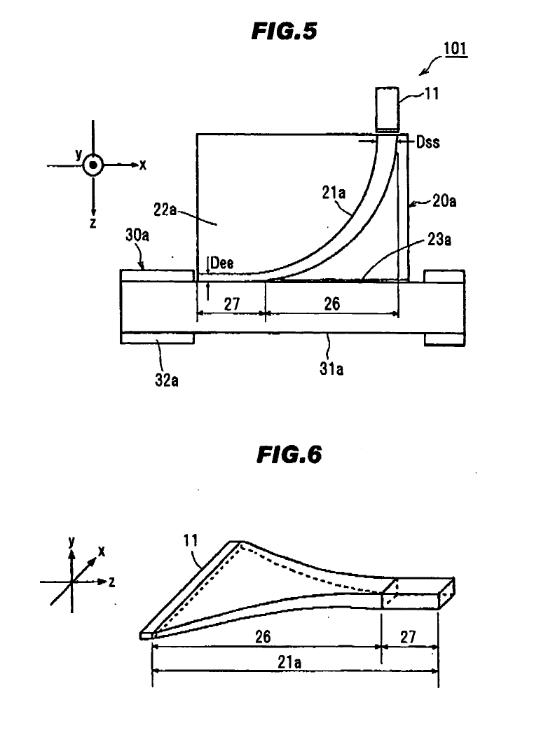

FIG. 5 is an explanatory diagram showing a core part 21a of an optical waveguide 20a in an optical waveguide type optical coupling arrangement 101 in the second preferred embodiment according to the invention.

FIG. 5 shows one of the light emitting elements 11 and the core part 21a of the optical waveguide 20a for guiding the laser light emitted from the light emitting element 11 along an xz-plane. The optical waveguide 20a comprises the core part 21a and a cladding part 22a. The optical fiber 30a comprises a core 31a and a cladding 32a. The core part 21a comprises a deformed part 26 and a coupling part 27 for coupling the deformed part 26 and the optical fiber 30a.

The deformed part 26 is deformed along a light guiding axis (y-axis) and the deformed part 26 changes a spread angle of the light propagated through the deformed part 26. Namely, the core part 21a comprises a mechanism for changing a spread angle of a light propagated therethrough by changing a shape of the core part 21a along a light guiding axis.

The spread angle of the light emitting element 11 in the x-axis direction is about 6′ that is less than an acceptance angle of the optical fiber 30a. Therefore, it is possible to realize the optical coupling with the optical fiber 30a, without modifying a width Dss of an end portion of the core part 21a of the optical waveguide 20a at the input side (i.e. at the side of the light emitting element 11).

Herein, this optical coupling between the core part 21a and the optical fiber 30a provides a Y-coupler. As described in Japanese Patent No. 3337691, a coupling ratio is proportional to a ratio of a squared diameter of a receiving fiber core (optical fiber core sectional area) to the squared diameter of a receiving fiber core (optical fiber core sectional area) plus a squared diameter of a feeding fiber core (optical waveguide core sectional area). Therefore, it is preferable to reduce the squared diameter of the feeding fiber core in order to realize the high efficiency optical coupling of the light from the feeding fiber core to the receiving fiber core.

Accordingly, it is possible to improve the coupling efficiency by reducing a width Dee of another end portion of the core part 21a of the optical waveguide 20a at the output side (i.e. at the side of the reflection coating 23a) to be approximately equal to the acceptance angle of the optical fiber 30a. Of course, when the spread angle of the core part 21a of the optical waveguide 20a is greater than the acceptance angle of the optical fiber 30a, the input light is not propagated through the optical fiber 30 after coupling, thereby generating the optical loss. Therefore, it is preferable that the spread angle of the core part 21a of the optical waveguide 20a at the coupling part 27 is not greater than the acceptance angle of the core 31a of the optical fiber 30a.

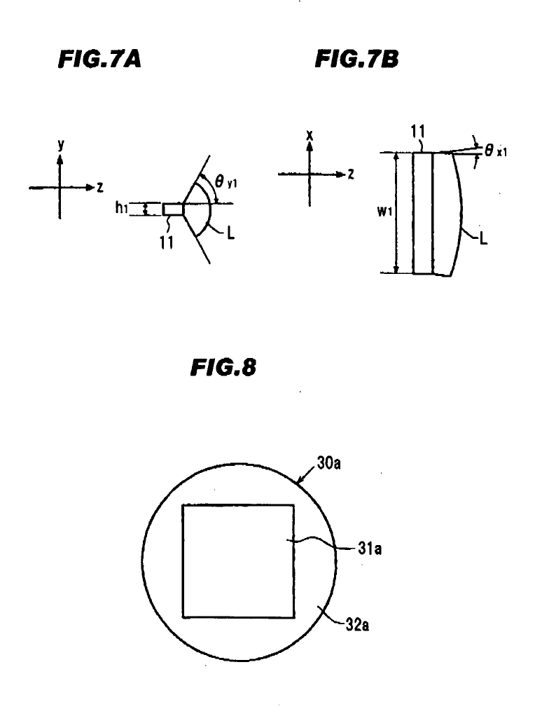

Herein, an example of the coupling efficiency will be explained with referring to FIG. 6 and FIGS. 7A and 7B.

FIG. 6 is a simplified schematic diagram showing a structure of the core part in the optical waveguide as shown in FIG. 5.

FIG. 7A and FIG. 7B are explanatory diagrams showing a relationship between a size of a light emitting element and an emission angle in the optical waveguide type optical coupling arrangement shown in FIG. 5.

The light emitting element 11 has an element width w1 of 100 μm in the x-axis direction in FIG. 6, and a height h1 of 1 μm. A divergence angle θy1 in the y-axis direction and a divergence angle θx1 in the x-axis direction of the laser light L of the light emitting element 11 are 60′ and 6′, respectively as shown in FIGS. 7A and 7B.

FIG. 6 shows the core part 21a in the optical waveguide 20a in a simplified manner The deformed part 26 of the core part 21a has a curved portion as shown in FIG. 5. However, the curved portion is expressed by straight lines for the purpose of simplification in FIG. 6.

FIG. 8 is a cross sectional view of the optical fiber 30a in the optical waveguide type optical coupling arrangement shown in FIG. 5.

It is preferable that the optical fiber 30a to which the laser light L is inputted has a flat bonding surface to be bonded with the optical waveguide 20a. For the purpose of simplified explanation, the optical fiber 30a comprises the core 31a doped with rare earth element such as Yb, Er, Tm and having a rectangular cross section with one side of 100 μm, and the cladding part 32a comprising a low refractive index resin as shown in FIG. 8. The NA of the optical fiber 30a is 0.46. In this preferred embodiment, the cross section of the core 31a is not limited to the rectangular shape. It is sufficient if the core 31a has a bonding surface to be bonded (coupled) to the optical fiber 20a, which is flat (parallel) with respect to a bonding (coupling) surface of the optical waveguide 20a.

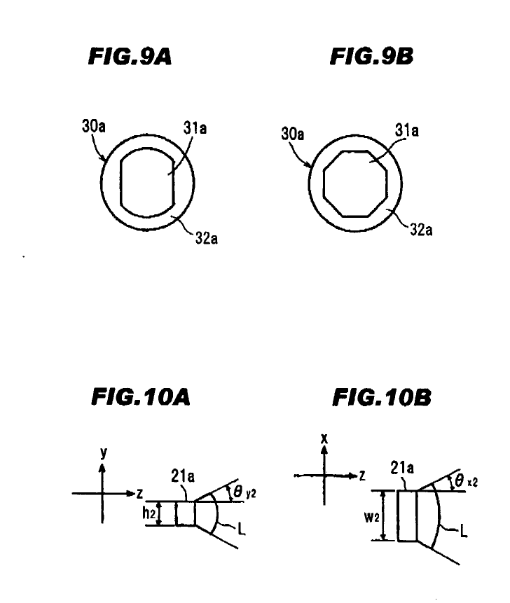

FIGS. 9A and 9B are cross sectional views of variations of optical fiber 30a in the optical waveguide type optical coupling arrangement shown in FIG. 5.

As described above, the core 31a may have a non-circular cross section such as a tambour shape as shown in FIG. 9A. Further, the core 31a may have polygonal cross section such as an octagonal shape as shown in FIG. 9B.

It is possible to calculate the acceptance angle of the optical fiber 30a from NA of the optical fiber 30a, which is about 28′. Herein, based on the formula (I) with treating the spread angles and the divergence widths in the respective axes independently, the divergence angles in the respective axes at the coupling part 27 of the optical waveguide 20a are calculated to be 28′, respectively.

FIG. 10A and FIG. 10B are explanatory diagrams showing a relationship between a size of an optical waveguide coupling part and an emission angle in the optical waveguide type optical coupling arrangement shown in FIG. 5.

As a result, the core part 21a of the optical waveguide 20a has a divergence height h2 of about 2 μm in the y-axis direction as shown in FIG. 10A and a divergence width w2 of about 23 μm in the x-axis direction as shown in FIG. 10B. In the core part 21 as configured above, a divergence angle θy2 in the y-axis direction and a divergence angle θx2 in the x-axis direction of the laser light L are 28′, respectively, which are approximately equal to the acceptance angle of the optical fiber 30a.

As described above, the coupling ratio is proportional to the receiving optical fiber core sectional area to the receiving optical fiber core sectional area plus the optical waveguide core sectional area. In the second preferred embodiment, the receiving optical fiber core sectional area is 10000 μm² and the receiving optical fiber core sectional area plus the optical waveguide core sectional area is 10046 μm². Therefore, 99.5% of the light outputted from the core part 21a of the optical waveguide 20a is coupled to the core 31a of the optical fiber 30a.

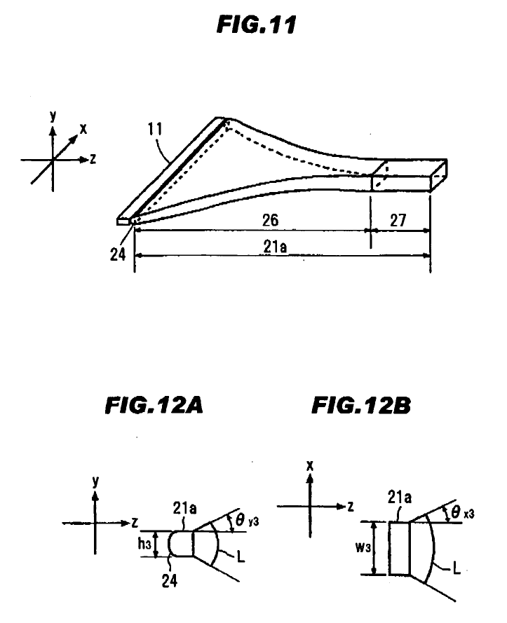

FIG. 11 is a simplified schematic diagram showing a structure of a variation of the core part 21a in the optical waveguide as shown in FIG. 6.

FIG. 12A and FIG. 12B are explanatory diagrams showing a relationship between a size of an input and output part and a divergence angle in the core part 21a shown in FIG. 11.

The core part 21a of the optical waveguide 20a has a divergence height h3 of about 2 μm in the y-axis direction as shown in FIG. 12A and a divergence width w3 of about 23 μm in the x-axis direction as shown in FIG. 12B. In the core part 21a as configured above, a divergence angle θy3 in the y-axis direction and a divergence angle θx3 in the x-axis direction of the laser light L are 28′, respectively, which are approximately equal to the acceptance angle of the optical fiber 30a.

As described with referring to FIG. 5, since the optical waveguide 20a has a plate-like shape, it is easy to conduct the processing in the y-axis direction. Accordingly, as shown in FIG. 11, a laser input side end surface 24 of the core part 21a of the optical waveguide 20a may have a convex cross section. Namely, the laser input side end surface 24 is polished to have a spherical surface in place of deforming the core shape of the core part 21a of the optical waveguide 20a in the y-axis direction, in order to provide an effect of providing a plano-convex cylindrical lens.

Concerning a method for processing a spherical surface of the laser input side end surface 24 and a method for setting a curvature for obtaining the effect of the piano-convex cylindrical lens, the detailed description thereof is omitted, since they are similar to conventional lens processing method and curvature setting method.

### Third Preferred Embodiment

Next, a coupling efficiency in the optical waveguide type optical coupling arrangement using the semiconductor laser bar comprising “BAC50c-9XX-03/04” and the optical waveguide will be explained.

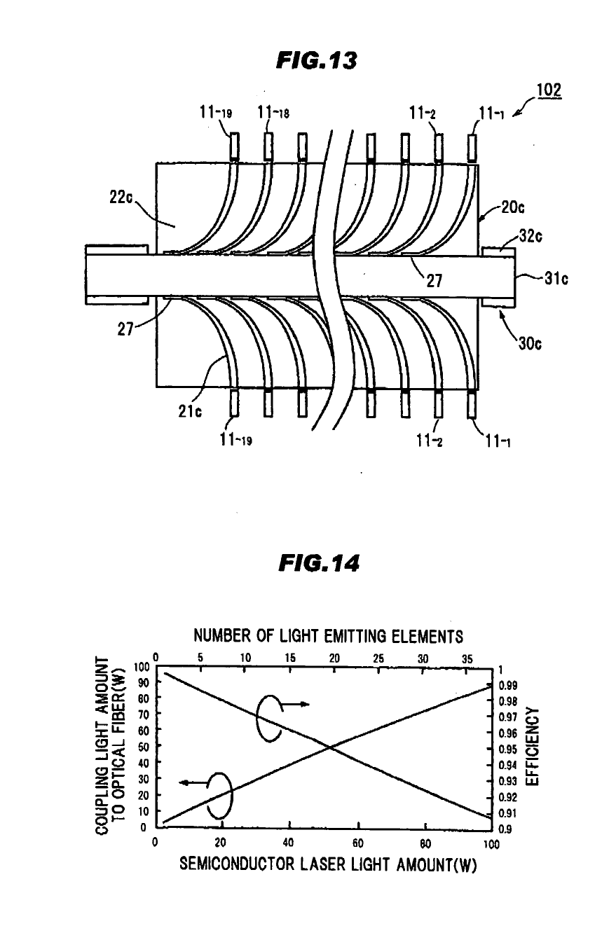

FIG. 13 is a schematic diagram of an optical waveguide type optical coupling arrangement 102 in a third preferred embodiment according to the present invention.

As shown in FIG. 13, in the optical waveguide type optical coupling arrangement 102, nineteen pieces of light emitting elements 11-1 to 11-19 of a semiconductor laser bar 10 are coupled to an optical fiber 30c via an optical waveguide 20c provided at each of both sides of the optical fiber 30c.

In more concrete, the optical waveguides 20c are provided at the both sides of the optical fiber 30c, respectively. Similarly to the core part 21a shown in FIG. 5, a core part 21c is formed in the optical waveguide 20c corresponding to each of the light emitting elements 11-1 to 11-19, and coupled to each of the light emitting elements 11-1 to 11-19. Thereafter, a coupling part 27 of each of the core parts 21c is coupled to the optical fiber 30c at the both sides of the optical fiber 30c.

In this structure, the laser light of a first light emitting element 11-1 is input to the optical fiber 30c, and 99.5% of the light quantity thereof is guided to the optical fiber 30c while 0.5% of the light quantity thereof as a remainder is lost at the coupling part 27 of the core part 21c of the optical waveguide 20c.

Next, the laser light of a second light emitting element 11-2 is input to the optical fiber 30c, and 99.5% of the light quantity thereof is guided to the optical fiber 30c while 0.5% of the light quantity thereof as a remainder is lost at a coupling part 27 of the core part 21c of the optical waveguide 20c. Further, 0.5% of the light coupled from the first light emitting element 11-1 guided through the optical fiber 30c is lost at the coupling part 27 of the core part 21c for the second light emitting element 11-2.

Finally, the laser light of a nineteenth light emitting element 11-9 is input to the optical fiber 30c, and 99.5% of the light quantity thereof is guided to the optical fiber 30c while 0.5% of the light quantity thereof as a remainder is lost at a coupling part 27 of the core part 21c of the optical waveguide 20c for the nineteenth light emitting element 11-9. Further, 0.5% of the lights coupled from the first light emitting element 11-1 to an eighteenth light emitting element 11-18 guided through the optical fiber 30c is lost at the coupling part 27 of the core part 21c for the nineteenth light emitting element 11-19.

FIG. 14 is a table of graphs showing a coupling efficiency of an input laser light to the optical fiber in the present invention.

FIG. 14 shows the light quantity of the light inputted to the optical fiber and the coupling efficiency in the case that the semiconductor laser bar 10 comprising two sets of the first to nineteenth light elements 11-1 to 11-19 are coupled to the optical fiber 30c.

Herein, a laser output power of each light emitting element 11 is 2.63 W. The output power of the semiconductor laser bar 10 comprising the first to nineteenth light emitting elements 11-1 to 11-19 in total is SOW. Since the loss of the light guided through the optical fiber 30c is generated at the coupling part 27, the coupling efficiency is decreased in accordance with an increase in the number of the light emitting elements 11.

However, even in the case that two semiconductor laser bars 10 (the number of the light emitting elements is thirty eight) are used, it is possible to obtain the coupling efficiency of 90%.

### Fourth Preferred Embodiment

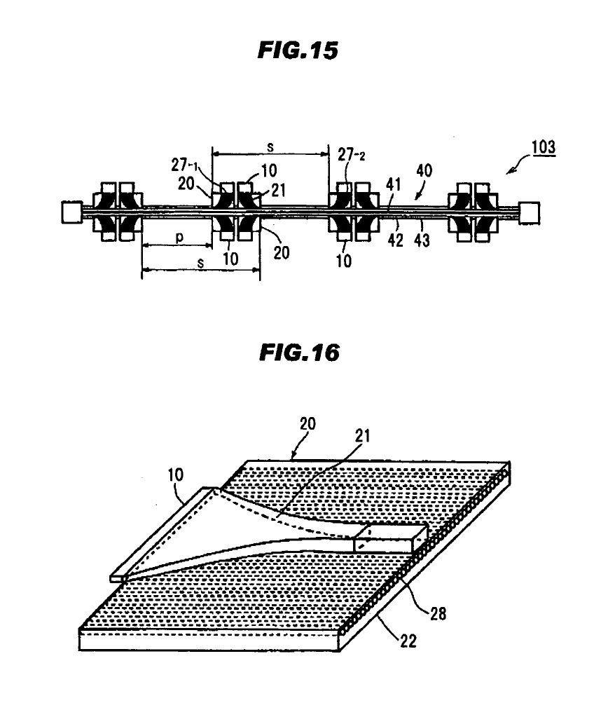

FIG. 15 is a schematic diagram of an optical waveguide type optical coupling arrangement 103 applied to an optical fiber laser in a fourth preferred embodiment according to the invention.

In the optical waveguide type optical coupling arrangement 103 as shown in FIG. 15, a laser output light is optically coupled to a double clad fiber 40 for an optical fiber laser via the optical waveguide 20. The double clad fiber 40 for an optical fiber laser comprises a rare earth element doped core 41 doped with Yb and having an outer diameter of about 5 μm, and two different claddings, namely an inner cladding 42 formed at an outer periphery of the rare earth element doped core 41, and an outer cladding 43 formed at an outer periphery of the inner cladding 42. The inner cladding 42 is provided as an exciting light propagation core for propagating an exciting light having a wavelength of 915 nm or 975 nm. An outer diameter of the outer core 43 is about 130 μm

A coating layer (not shown) comprising an ultraviolet (UV) curing resin is formed at an outer periphery of the outer cladding 43. An outer diameter of the coating layer is about 250 μm. For example, “YDF-5/130” manufactured by Nufern, Inc. may be used as a material of the coating layer.

A plurality (8×2 in FIG. 15) of the optical waveguides 20 are coupled to the double clad fiber 40 for an optical fiber laser. A core part 21 of each of the optical waveguide 20 is coupled to a side surface of the inner cladding (the exciting light propagating core) 42.

The laser output light of the semiconductor laser bar 10 is optically coupled to the exciting light propagation core 42 via the optical waveguide 20. As a result, a laser light with a wavelength of 1030 nm to 1080 nm is emitted. A plurality of the light emitting elements 11, by which the optical coupling with a predetermined efficiency (for example, 90%) or more is possible as shown in FIG. 14, are coupled. An optical coupling part 27-1 of the optical waveguide 20 for a semiconductor laser bar 10 and an optical coupling part 27-2 of the optical waveguide 20 for another semiconductor laser bar 10 are arranged with a constant distance “s” corresponding to, for example, a fiber length of the double clad fiber 40 for an optical fiber laser by which 90% or more of the exciting light is absorbed.

According to this structure, the laser light coupled from the semiconductor laser bar 10 and propagated through the exciting light propagation core 42 is absorbed by the rare earth element doped core 41. Therefore, by arranging another set of the semiconductor laser bar 10 and the optical waveguide 20 after the absorption of the exciting light by the rare earth element doped core 41, it is possible to optically couple a large quantity of the exciting lights (the laser lights) to a single piece of the double clad fiber 40 for an optical fiber laser.

Further, as shown in FIG. 15, the optical waveguide 20 having a symmetrical structure are arranged to be opposed to each other with a pitch “p”, and the propagation light is propagated in both directions along a longitudinal direction of the double clad fiber 40 for an optical fiber laser.

According to this structure, almost all of the exciting light is absorbed by a part of the double clad fiber 40 for an optical fiber laser corresponding to the pitch p. Further, the amount of the exciting light absorbed by a part of the double clad fiber 40 for an optical fiber laser corresponding to the pitch s is increased by two times. Still further, a heat generation due to the light absorption can be equalized along the longitudinal direction of the double clad fiber 40 for an optical fiber laser, namely, the absorbed light quantity can be equalized along the longitudinal direction of the double clad fiber 40 for an optical fiber laser.

### (Structure of the Optical Waveguide)

Next, an example of the optical waveguide structure used in the present invention will be explained.

In the optical waveguide structure according to the present invention, the core part 21 of the optical waveguide 20 comprises a material same as the core of the optical fiber to be coupled or a material having a refractive index same as that of the core of the optical fiber to be coupled. For example, when an optical fiber comprising an exciting light propagation core comprising quartz (silica) is used, it is preferable to choose the quartz as material of the core part 21 of the optical waveguide 20. In this case, it is preferable that the cladding 22 of the optical waveguide 20 comprises a material having a refractive index lower than that of the quartz, for example, quartz doped with F.

FIG. 16 is a schematic diagram of a perspective view of an optical waveguide structure in the optical waveguide type optical coupling arrangement according to the invention.

As shown in FIG. 16, the cladding part 22 may be formed to constitute a clad structure comprising air holes 28, thereby reducing an effective refractive index. At this time, similar air holes may be formed around the core part 21. In order to easily manufacturing the clad structure, a cladding part comprising the air holes 28 may be provided only at a bottom side of the core part 21 of the optical waveguide 20, and an air cladding may be provided at side surfaces and an upper side of the core part 21 of the optical waveguide 20. Alternatively, the core part 21 of the optical waveguide 20 may be covered with a resin having a low refractive index, for example, the same material used in the clad 32a comprising the low refractive index resin in FIG. 8.

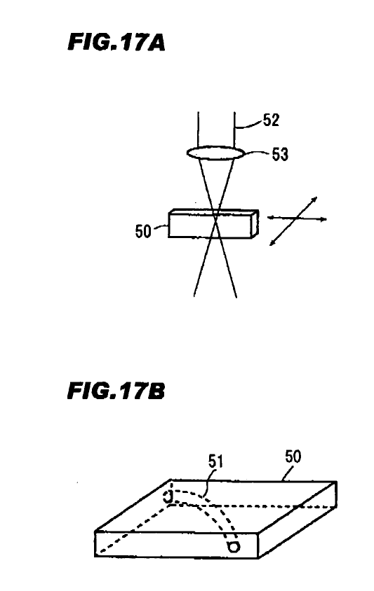

FIGS. 17A and 1713 are explanatory diagrams showing a method for forming an optical waveguide core in the optical waveguide structure in the invention.

As shown in FIG. 17A, a pulse laser light 52 is irradiated via a collecting lens 53 to a glass 50 having a refractive index lower than the quartz (for example, fluoride glass). As shown in FIG. 17B, an optical waveguide core 51 having a desired shape may be formed in the glass 50.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. An optical waveguide type optical coupling arrangement comprising:
a semiconductor laser bar comprising a plurality of light emitting elements arranged in parallel;
an optical waveguide comprising a core part for guiding a light emitted from each of the light emitting elements in the semiconductor laser bar and a cladding part formed around the core part, and
an optical fiber comprising a core and a cladding formed around the core for confining the light into the core;
wherein the optical waveguide is bonded to a side surface of the optical fiber,
wherein the light emitted from the laser bar is input to a side surface of the core of the optical fiber.

2. The optical waveguide type optical coupling arrangement, according to claim 1, wherein the core part of the optical waveguide has a tapered shape such that a spread angle of the light emitted from the light emitting element is not greater than an acceptance angle of the optical fiber.

3. The optical waveguide type optical coupling arrangement, according to claim 1, wherein a size of the core part of the optical waveguide at an output end side is determined such that a spread angle of the light at the output end side is not greater than an acceptance angle of the optical fiber.

4. The optical waveguide type optical coupling arrangement, according to claim 1, wherein the core of the optical fiber comprises a bonding surface bonded to the optical a waveguide, the optical waveguide comprises a bonding surface bonded to the core, and the bonding surface of the core is flat to the bonding surface of the optical waveguide.

5. The optical waveguide type optical coupling arrangement, according to claim 1, wherein the core part comprises a mechanism for changing a spread angle of a light propagated therethrough by changing a shape of the core part along a light guiding axis.

6. The optical waveguide type optical coupling arrangement, according to claim 1, wherein the core part comprises a deformed part that is deformed along a light guiding axis and the deformed part changes a spread angle of a light propagated through the deformed part.

7. The optical waveguide type optical coupling arrangement, according to claim 1, wherein the core part of the optical waveguide comprises a side surface facing to the semiconductor laser bar and the side surface of the core part is lens-processed.

8. The optical waveguide type optical coupling arrangement, according to claim 1, wherein the core part of the optical waveguide comprises a side surface facing to the semiconductor laser bar, and the side surface of the core part has a convex cross section.

9. The optical waveguide type optical coupling arrangement, according to claim 1, wherein:
the optical waveguide changes a direction of the light emitted from each of the light emitting elements and propagated through the core part and guides the light to a side surface of the optical fiber.

10. The optical waveguide type optical coupling arrangement, according to claim 1, wherein:
the optical fiber comprises a double clad fiber for an optical fiber laser, comprises a core doped with a rare earth element, and two different claddings formed around the core.

11. An optical waveguide for the optical waveguide type optical coupling arrangement according to claim 1, comprising:
a core part for guiding a light emitted from each of the light emitting elements in the semiconductor laser bar; and
a cladding part formed around the core part,
wherein the core part comprises a deformed part that is deformed along a light guiding axis and the deformed part changes a spread angle of a light propagated through the deformed part.
